(19) United States
(12) Patent Application Publication
(10) Pub. No.: US 2026/0075294 A1
(43) Pub. Date: Mar. 12, 2026

(54) APPROACHES TO MULTIMEDIA EDITING USING AN ARTIFICIAL INTELLIGENCE MODEL AND SYSTEMS FOR ACCOMPLISHING THE SAME

(71) Applicant: Descript, Inc., San Francisco, CA (US)

(72) Inventors: David Dodero, San Francisco, CA (US); Katrina Lui, San Francisco, CA (US); Raymond Yuan, San Francisco, CA (US); Ajay Arasanipalai, San Francisco, CA (US); Cora Lam, San Francisco, CA (US); Pranav Ramabhadran, San Francisco, CA (US)

(21) Appl. No.: 19/316,409

(22) Filed: Sep. 2, 2025

Related U.S. Application Data
(60) Provisional application No. 63/692,561, filed on Sep. 9, 2024.

(51) Int. Cl. H04N 21/81; H04N 21/431; H04N 21/466

(52) U.S. Cl. CPC H04N 21/816; H04N 21/4318; H04N 21/4666

(57) ABSTRACT

The disclosed technology uses a media production platform to edit multimedia files with an AI model (e.g., a neural network). The technology can remove retakes, identify highlight clips, and/or generate layouts for multimedia files. The technology can process audio transcripts to exclude retakes by generating a refined transcript and highlighting removed segments. Additionally, the technology can edit audiovisual files by generating scenes based on content and mapping the scenes to relevant layouts, dynamically adjusting based on user input. The technology can generate highlights by applying AI models to create clips and identify topics within the audiovisual file, producing an edited file indicative of the topics. The results, such as the edited files, are presented on the client device.

### CROSS-REFERENCE TO RELATED APPLICATIONS

This application claims priority to U.S. Provisional Application No. 63/692,561, filed Sep. 9, 2024, entitled “APPROACHES TO MULTIMEDIA EDITING USING AN ARTIFICIAL INTELLIGENCE MODEL AND SYSTEMS FOR ACCOMPLISHING THE SAME” the entirety of which is incorporated herein by reference.

### TECHNICAL FIELD

Various embodiments concern computer programs and associated computer-implemented techniques for modifying audiovisual files.

### BACKGROUND

Multimedia editing includes the process of manipulating and arranging text, video, audio, and/or image content to create a final product. For example, multimedia editing can include cutting and splicing video clips, adjusting audio levels, adding special effects, and incorporating graphics and animations. With the proliferation of digital content across various platforms, multimedia editing has become more widespread in numerous industries, including film and television, advertising, online content creation, and corporate communications. However, editors have traditionally relied on manual processes to review extensive footage and/or portions of the transcript, identify relevant segments, and piece the segments together into a coherent final product. Traditional editing methods are labor-intensive, time-consuming, and prone to human error, particularly with tasks such as finding the best takes and synchronizing audio and video. Moreover, removing retakes using traditional methods is difficult while maintaining narrative coherence. Editors might rely on visual and auditory cues to identify retakes, which can be ambiguous or difficult to distinguish, especially in complex scenes with multiple elements. Further, determining highlights in traditional multimedia editing often introduces biases that significantly affect the quality and relevance of the final highlight reel. Consequently, the edited media file may include inconsistencies and repetitive segments that detract from the overall quality of the production, negatively impacting the overall user experience.

Artificial intelligence (“AI”) models—also called “machine learning models,” “machine learnt models,” or simply “models”—often operate based on relationships learned from extensive and enormous datasets called “training datasets.” The training datasets include a multiplicity of inputs and labels that indicate how each should be handled. From a training dataset, an algorithm can learn relationships between inputs and labels and represent these learned relationships as a model. Then, when the model receives a new input, the model produces an output based on the relationships learned from the training dataset that the model was trained on. AI models have been developed and trained to perform various tasks, leading to improvements in performance and fundamentally altering how those tasks are approached and executed. Through iterative training processes, models can extract insights, make predictions, and uncover trends that may not be apparent to human observers.

### BRIEF DESCRIPTION OF THE DRAWINGS

FIG. 1 illustrates a network environment that includes a media production platform.

FIG. 2 illustrates an example of a computing device able to implement a media production platform through which individuals may be able to record, produce, deliver, or consume media content.

FIG. 3 is a block diagram illustrating an example environment of modified transcripts of an audio file.

FIG. 4 depicts a flow diagram of a process for removing retakes in a transcript using an AI model.

FIG. 5 is a block diagram illustrating an example environment of generated layouts of an audiovisual file.

FIG. 6 depicts a flow diagram of a process for generating layouts for an audiovisual file using an AI model.

FIG. 7 is a block diagram illustrating an example environment of generated highlight clips of an audiovisual file.

FIG. 8 depicts a flow diagram of a process for generating highlight clips of an audiovisual file using an AI model.

FIG. 9 is a high-level block diagram illustrating an example AI system, in accordance with one or more embodiments.

FIG. 10 is a block diagram illustrating an example computer system, in accordance with one or more embodiments.

Features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the present disclosure. Accordingly, although specific embodiments are shown in the drawings, the technology is amenable to various modifications.

### DETAILED DESCRIPTION

Traditional approaches to editing multimedia compilations comprised of video content, audio content, or image content have often been labor-intensive and time-consuming. Consider a multimedia compilation that includes segments of video content from different sources or files. To construct the multimedia compilation, an editor would have manually reviewed extensive footage, identified relevant segments, and then pieced those segments together into a coherent final product. This process is not only inefficient but also prone to human error. Editing tasks, such as finding the best takes, synchronizing audio with video, and applying consistent visual effects, can lead to oversight, affecting the quality and consistency of the output. This process can also be particularly challenging with long-form content, where identifying and categorizing significant sections can become overwhelming—especially if editors are tasked with reviewing that long-form content in a short period of time (e.g., hours rather than days or weeks).

Editors may also struggle to maintain a cohesive narrative with this process. For example, removing retakes using traditional methods is difficult to maintain narrative coherence. To create high-quality multimedia compilations, editors need to ensure that the transitions between the selected takes—and between different types of content—are smooth and that the overall flow remains intact, as abrupt changes or awkward cuts can disrupt the viewer's immersion and negatively impact the storytelling. With traditional approaches, this integration is achieved through iterative revisions, further extending the editing timeline and increasing the resources needed. This iterative approach to achieving integration is even more burdensome if content is added or removed later in the editing timeline, as the editor may need to begin anew to ensure that the narrative remains coherent despite the addition or deletion of content.

Traditional methods of removing retakes also lack precision and objectivity. Editors might rely on visual and auditory cues to identify retakes, which can be ambiguous or difficult to distinguish, especially in complex scenes with multiple elements. This can result in either redundant content being included in the final product or valuable footage being inadvertently discarded. The final edited version may still contain inconsistencies and repetitive segments that detract from the overall quality of the production.

Further, determining outstanding or important segments of content—more commonly called “highlights”—in traditional methods of multimedia editing often introduces biases that can significantly affect the quality and relevance of the final highlight reel. Since editors have subjective judgment influenced by their personal tastes, cultural background, and/or experiences, the editors may prioritize segments that resonate with them but do not necessarily reflect the broader audience's preferences. The subjectivity can lead to the selection of highlights that are not universally engaging or representative of the highlighted moments in the content.

Introduced here are computer programs and associated computer-implemented techniques for using a media production platform to edit multimedia files using an AI model. The AI model may be trained to remove retakes, identifying highlight clips, and/or generating layouts for multimedia files. For the purpose of illustration, the AI model may be described as a neural network. However, those skilled in the art will recognize that another algorithm—and therefore, another type of model—could be used without deviating from the features of the embodiments described below.

Unlike traditional methods of multimedia editing, the media production platform can remove retakes from a transcript within an audio file using an AI model. From a received transcript of an audio file from a client device, which includes one or more retakes, the system can generate another transcript excluding identified retakes. The retakes are identified as segments indicative of corresponding words in subsequent segments. The AI model processes this first transcript to generate a second transcript that includes only the necessary segments and excludes the identified retakes. By iteratively mapping the original transcript and the generated transcript, the system can generate a set of indicators highlighting the words absent from the second transcript. The set of indicators can be presented on the client device to enable users to visualize and manage the removal of retakes.

Additionally, unlike traditional methods of multimedia editing, the media production platform can edit audiovisual files (e.g., videos) received from a client device to generate scenes based on the content of the audiovisual file using an AI model. The system obtains, from a client device, an original audiovisual file and a transcript representing the spoken words within the original audiovisual file. The system obtains a set of layouts, each assigned a relevancy score corresponding to different portions of the original audiovisual file. By applying an AI model, the platform processes the original audiovisual file and transcript to generate a set of scenes. Each scene is mapped to the most relevant layout based on the assigned scores. The result is an edited audiovisual file composed of the mapped scenes, which can be presented on the client device. The media production platform can incorporate user input and dynamically adjust layouts based on parameters such as cooldown and keyword relevance.

Further, unlike traditional methods of multimedia editing, the media production platform can generate highlights for a received audiovisual file using an AI model. The media production platform can receive input from a client device including (i) an original audiovisual file and (ii) a transcript of the audiovisual file. The media production platform applies a first AI model to generate a series of clips using the inputs, each corresponding to portions of the original audiovisual file. The media production platform applies a second AI model to identify a set of topics within the original audiovisual file by processing the same inputs. The system determines if each clip from the first set is representative of these topics and generates an edited audiovisual file that includes clips indicative of at least one topic. The multimedia editing platform can present an indicator of the edited audiovisual file on the client device.

For the purpose of illustration, embodiments may be described in the context of improving the quality of edited multimedia files. However, those skilled in the art will recognize that the approaches described herein may be similarly applicable to other multimedia domains. Accordingly, the approaches described herein are not limited to improving the editing quality of multimedia files.

Note that while embodiments may be described in the context of computer-executable instructions for the purpose of illustration, aspects of the technology can be implemented via hardware, firmware, software, or any combination thereof. As an example, a media production platform may be embodied as a computer program through which an individual may be permitted to review content (e.g., text, audio, or video) to be incorporated into a media compilation, create media compilations by compiling different forms of content or multiple files of the same form of content, and initiate playback or distribution of media compilations.

### Overview of Media Production Platform

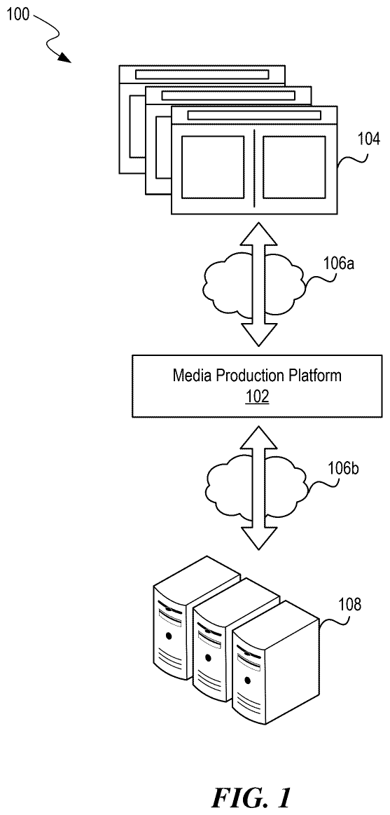

FIG. 1 illustrates a network environment 100 that includes a media production platform 102. Individuals (also referred to as “users” or “developers”) can interact with the media production platform 102 via interfaces 104 as further discussed below. For example, individuals may be able to generate, edit, or view media content through the interfaces 104. Examples of media content include text content such as stories and articles, audio content such as radio segments and podcasts, and video content such as television programs and presentations. Meanwhile, the individuals may be persons interested in recording media (e.g., audio content) or editing media (e.g., to create a podcast or audio tour).

As shown in FIG. 1, the media production platform 102 may reside in a network environment 100. Thus, the computing device on which the media production platform 102 is executing may be connected to one or more networks 106a-b. The network(s) 106a-b can include personal area networks (PANs), local area networks (LANs), wide area networks (WANs), metropolitan area networks (MANs), cellular networks, the Internet, etc. Additionally or alternatively, the computing device can be communicatively coupled to other computing device(s) over a short-range wireless connectivity technology, such as Bluetooth®, Near Field Communication (NFC), Wi-Fi® Direct (also referred to as “Wi-Fi P2P”), and the like. As an example, the media production platform 102 is embodied as a “cloud platform” that is at least partially executed by a network-accessible server system in some embodiments. In such embodiments, individuals may access the media production platform 102 through computer programs executing on their own computing devices. For example, an individual may access the media production platform 102 through a mobile application, desktop application, over-the-top (OTT) application, or web browser. Accordingly, the interfaces 104 may be viewed on personal computers, tablet computers, mobile phones, wearable electronic devices (e.g., watches or fitness accessories), network-connected electronic devices (also called “smart electronic devices”) such as televisions or home assistant devices), gaming consoles, virtual or augmented reality systems (e.g., head-mounted displays), and the like.

In some embodiments, at least some components of the media production platform 102 are hosted locally. That is, part of the media production platform 102 may reside on the computing device that is used to access the interfaces 104. For example, the media production platform 102 may be embodied as a desktop application executing on a personal computer. Note, however, that the desktop application may be communicatively connected to a network-accessible server system 108 on which other components of the media production platform 102 are hosted.

In other embodiments, the media production platform 102 is executed entirely by a cloud computing service operated by, for example, Amazon Web Services®, Google Cloud Platform™, or Microsoft Azure®. In such embodiments, the media production platform 102 may reside on a network-accessible server system 108 comprised of one or more computer servers. These computer servers can include media and other assets, such as digital signal processing algorithms (e.g., for processing, coding, or filtering audio signals), heuristics (e.g., rules for determining whether to improve the quality of incoming audio signals, rules for determining the degree to which the quality of incoming audio signals should be improved), and the like. Those skilled in the art will recognize that this information could also be distributed amongst a network-accessible server system and one or more computing devices. For example, media content may be stored on a personal computer that is used by an individual to access the interfaces 104 (or another computing device, such as a storage medium, that is accessible to the personal computer) while digital signal processing algorithms may be stored on a computer server that is accessible to the personal computer via a network.

As further discussed below, the media production platform 102 can facilitate the production of studio-quality recordings (called “studio sound files” or “studio audio files”) through the application of a trained model on waveforms corresponding to lesser-quality recordings. Generally, these waveforms are obtained by the media production platform 102 in the form of audio files. Thus, an individual may be able to select an audio file and specify that the quality of the audio file should be improved. Alternatively, upon receiving input indicative of a selection of an audio file, the media production platform 102 may automatically improve the media production platform's 102 quality in response to determining that the quality (e.g., as measured in clarity, signal-to-noise ratio, etc.) either falls beneath a threshold or is meaningfully less than other audio files to be included in the same media compilation. In some embodiments, the media production platform 102 is programmed to automatically improve the quality of all audio files that are selected, identified, or otherwise made available for inclusion in media compilations by the media production platform 102.

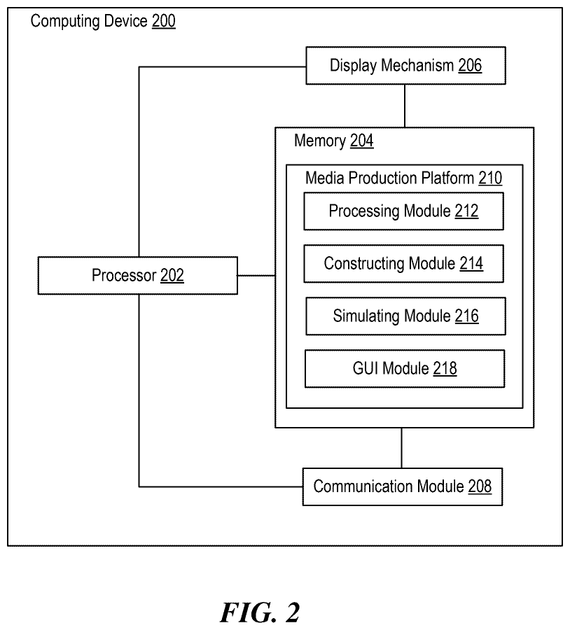

FIG. 2 illustrates an example of a computing device 200 able to implement a media production platform 210 through which individuals may be able to record, produce, deliver, or consume media content. For example, in some embodiments, the media production platform 210 is designed to generate interfaces through which developers can generate or produce media content, while in other embodiments the media production platform 210 is designed to generate interfaces through which consumers can consume media content. In some embodiments, the media production platform 210 is embodied as a computer program that is executed by the computing device 200. In other embodiments, the media production platform 210 is embodied as a computer program that is executed by another computing device (e.g., a computer server) to which the computing device 200 is communicatively connected. In such embodiments, the computing device 200 may transmit relevant information, such as media content created, recorded, or otherwise acquired by the individual, to the other computing device for processing. Those skilled in the art will recognize that aspects of the computer program could also be distributed amongst multiple computing devices.

The computing device 200 can include a processor 202, memory 204, display mechanism 206, and communication module 208. The communication module 208 may be, for example, wireless communication circuitry designed to establish communication channels with other computing devices. Examples of wireless communication circuitry include integrated circuits (also referred to as “chips”) configured for Bluetooth, Wi-Fi, NFC, and the like. The processor 202 can have generic characteristics similar to general-purpose processors, or the processor 202 may be an application-specific integrated circuit (ASIC) that provides control functions to the computing device 200. As shown in FIG. 2, the processor 202 can be coupled to all components of the computing device 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the modules of the media production platform 210). Note that the memory 204 is merely an abstract representation of a storage environment. The memory 204 could be comprised of actual memory chips or modules.

The communication module 208 can manage communications between the components of the computing device 200. The communication module 208 can also manage communications with other computing devices. Examples of computing devices include mobile phones, tablet computers, personal computers, and network-accessible server systems comprised of one or more computer servers. For instance, in embodiments where the computing device 200 is associated with a developer, the communication module 208 may be communicatively connected to a network-accessible server system on which processing operations, heuristics, and algorithms for producing media content are stored. In some embodiments, the communication module 208 facilitates communication with one or more third-party services that are responsible for providing specified services (e.g., transcription or speech generation). The communication module 208 may facilitate communication with these third-party services through the use of application programming interfaces (APIs), bulk data interfaces, etc.

For convenience, the media production platform 210 may be referred to as a computer program that resides within the memory 204. However, the media production platform 210 could be comprised of software, firmware, or hardware implemented in, or accessible to, the computing device 200. In accordance with embodiments described herein, the media production platform 210 may include a processing module 212, constructing module 214, simulating module 216, and graphical user interface (GUI) module 218. These modules may be an integral part of the media production platform 210. Alternatively, these modules may be logically separate from the media production platform 210 but operate “alongside” it. Together, these modules enable the media production platform 210 to generate and support the interfaces through which an individual can create, record, edit, or consume media content.

The processing module 212 may be responsible for ensuring that data obtained (e.g., retrieved or generated) by the media production platform 210 is in a format suitable for the other modules. Thus, the processing module 212 may apply operations to alter media content obtained by the media production platform 210. For example, the processing module 212 may apply denoising, filtering, and/or compressing operations to media content obtained by the media production platform 210. As noted above, media content could be acquired from one or more sources. The processing module 212 may be responsible for ensuring that these data are in a compatible format, temporally aligned, etc.

As further discussed below, the constructing module 214 may design, develop, or train a model that takes a first waveform as input, converts the first waveform into a representation, and converts the representation into a second waveform. The model may be representative of a concatenation of multiple models, and therefore may be referred to as a “superset model.” More specifically, this model may include (i) a first set of algorithms—representative of a first model—that is able to produce the representation from the first waveform and (ii) a second set of algorithms—representative of a second model—that is able to produce the second waveform from the representation. As discussed above, the first model may be representative of a “reverse” vocoder while the second model may be representative of a “forward” vocoder.

At a high level, the superset model is representative of a machine learning framework that includes the first and second models. The constructing module 214 may not only be responsible for developing the superset model, but also the first and second models. For example, the constructing module 214 may be responsible for identifying a “forward” vocoder that can be used as the second model and developing an appropriate “backward” vocoder based on the “forward” vocoder. The constructing module 214 may identify the “forward” vocoder from amongst a series of “forward” vocoders based on the desired capabilities of the superset model. For example, the “forward” vocoder could be identified based on a desired quality (e.g., in terms of signal-to-noise ratio, gain, or some other characteristic) of the “clean” audio to be output by the superset model.

In some embodiments, the constructing module 214 is responsible for training the superset model. Assume, for example, that the superset model is representative of a GAN. In such a scenario, the constructing module 214 can train the superset model in an adversarial manner, namely, with a generator and an encoder. To ensure good performance, the constructing module may utilize two losses, namely, an adversarial loss and a reconstruction loss, during the training process. Training is discussed in further detail below.

In other embodiments, a separate module may be responsible for training the superset model designed, developed, or otherwise obtained by the constructing module 214. This other module may be referred to as a “training module.” The training module could be part of the media production platform 210, or the training module may be accessible to the media production platform 210. For example, the training module may be executed by another computing device to which the computing device 200 is communicatively connected.

Accordingly, the constructing module 214 may be responsible for designing, developing, or training (e.g., in conjunction with the training module) the superset model that is applied by the simulating module 216. Assume, for example, that the media production platform 210 acquires input indicative of a request to improve the quality of a first audio file. Upon acquiring the input, the simulating module 216 can acquire the first audio file. In some embodiments, the first audio file is included in the input. For example, a user may upload the first audio file to the media production platform 210 through an interface that is generated by the GUI module 218, and the act of uploading the first audio file may be indicative of the input. In other embodiments, the first audio file is referenced in the input. For example, the input may reference the name of the first audio file, a speaker whose voice is included in the first audio file, or a media compilation that the first audio file is to be used to create. In embodiments where the first audio file is referenced in the input, the simulating module 216 may acquire the first audio file. For example, the simulating module 216 may retrieve the first audio file from the memory 204, or the simulating module 216 may retrieve the first audio file from another memory that is accessible (e.g., by the communication module 208) via a network.

The simulating module 216 can apply the superset model to the first audio file, so as to produce a second audio file as output. As further discussed below, applying the superset model to the first audio file may result in manipulation of the underlying audio signal. The underlying audio signal can be manipulated to sound as if recording occurred with sophisticated equipment in a high-quality recording studio. As such, the second audio file may be referred to as a “studio sound file” or “studio audio file.” Studio sound values obtained by the simulating module 216 through application of the superset model can be stored in the memory 204 or another memory external to the computing device 200. In some embodiments, studio sound files are stored in data structures that correspond to media compilations. For example, each studio sound file may be stored in a data structure maintained for a media compilation in which that studio sound file is to be used.

The GUI module 218 may be responsible for generating the interfaces through which users can interact with the media production platform 210. The interfaces may include visual indicia representative of the audio files (e.g., studio sound files) that can be used to create a media compilation, or these interfaces may include a transcript that can be edited to globally effect changes to a corresponding media compilation. For example, if a user deletes a segment of a transcript that is visible on an interface, the media production platform 210 may automatically delete a corresponding segment of audio content from an audio file (e.g., a studio sound file) associated with the transcript.

### Removing Retakes Using an AI Model

Retakes, where speakers repeat words, phrases, or sentences potentially due to mistakes, stumbles, or the desire to rephrase for clarity, can introduce significant redundancy and disrupt the flow of a textual transcript. For example, in some audio recordings, users often perform retakes to achieve the desired tone and delivery, while in dictations, users may retake sections to ensure accuracy and completeness. Retakes can disrupt the flow of the transcript and introduce redundancy, making it challenging to produce a clean and coherent textual representation of the spoken content. The disclosed system identifies and removes retakes by analyzing the transcript for repeated segments using an artificial intelligence (AI) model. The AI model compares successive segments within the transcript to retain the most relevant segment while excluding redundant repetitions, and outputs a refined transcript. By identifying and removing the retakes, the technology ensures that the final transcript accurately reflects the intended spoken content without unnecessary repetitions, thereby enhancing the readability and usability of the transcript.

For the purpose of illustration, embodiments may be described in the context of improving the quality of edited multimedia files by removing retakes. However, those skilled in the art will recognize that the approaches described herein may be similarly applicable to other multimedia domains. For example, the same techniques can be generalized to edit multimedia files for clarity. The disclosed embodiments can be used to improve the coherence and clarity of unscripted recordings by removing filler words, tangents, and unfocused thoughts. In unscripted recordings such as interviews, podcasts, or live discussions, speakers often include filler words like “um,” “uh,” and “you know,” which can detract from the overall clarity and professionalism of the content. Additionally, speakers may go off on tangents or present unfocused thoughts that do not contribute to the main narrative. Using the disclosed approach, the system can identify and remove the elements, resulting in a more concise and focused transcript. This not only enhances the listener's experience but also ensures that the key messages are communicated more effectively.

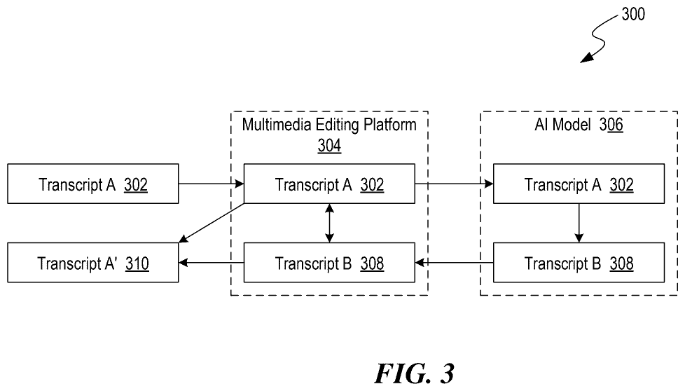

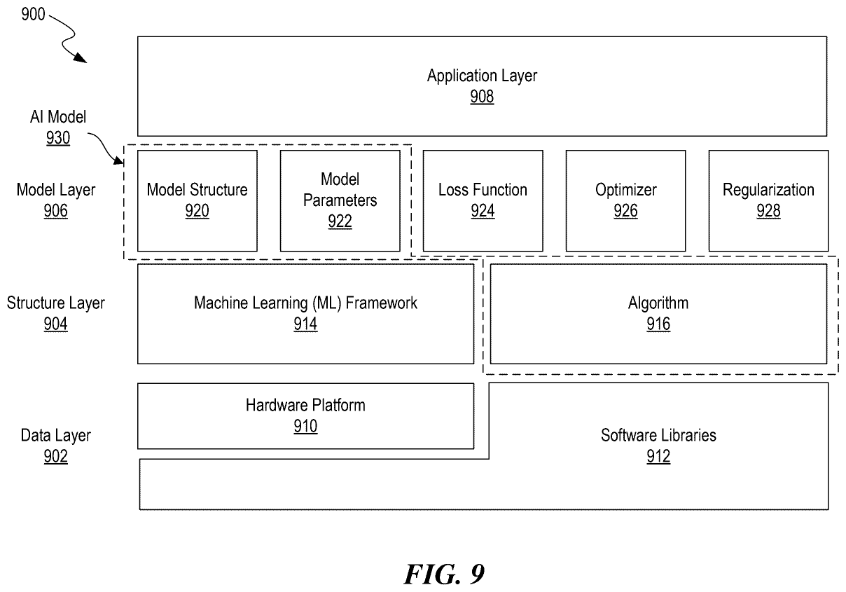

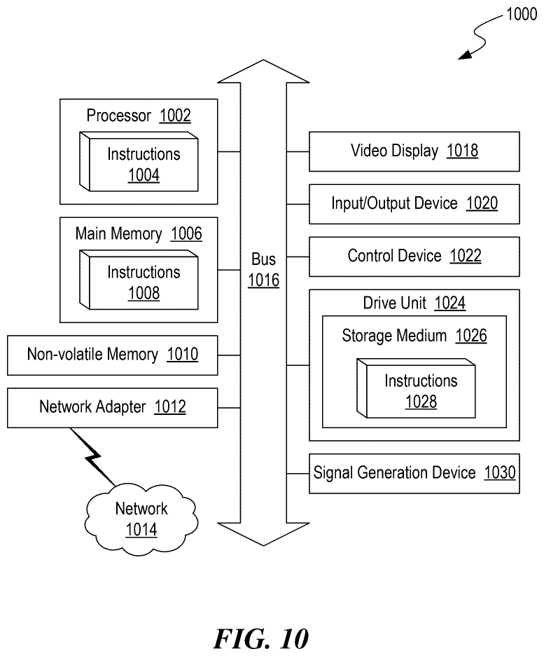

FIG. 3 is a block diagram illustrating an example environment 300 of modified transcripts of an audio file. The example environment 300 includes transcripts 302, 308, 310, multimedia editing platform 304, and AI model 306. Multimedia editing platform 304 is the same as or similar to media production platform 102 and media production platform 210 illustrated and described in more detail with reference to FIG. 1 and FIG. 2, respectively. AI model 306 is the same as or similar to AI model 930 illustrated and described in more detail with reference to FIG. 9. The example environment 300 can be implemented using components of the example computer system 1000 illustrated and described in more detail with reference to FIG. 10. Likewise, embodiments of the example environment 300 can include different and/or additional components that can be connected in different ways.

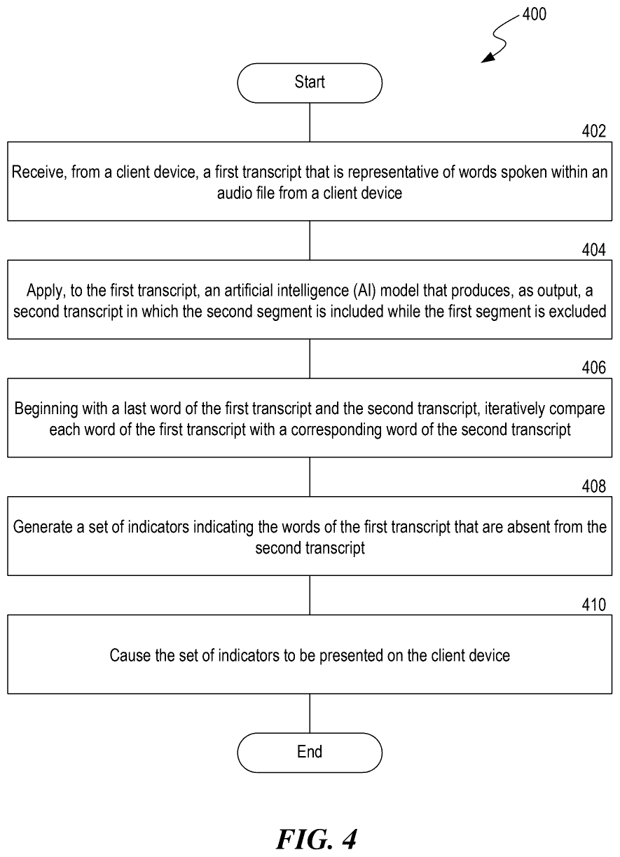

Transcripts 302, 308, and 310 each represent different stages of the textual representation of spoken words within an audio file. The initial transcript (e.g., transcript A 302) is the initial version received by the multimedia editing platform 304. The initial transcript 302 can include all spoken words of a user, including any retakes. In some embodiments, the initial transcript 302 is generated using automatic speech recognition (ASR) technology, which converts the audio signals into text using, for example, machine learning models that identify phonetic elements, words, and sentences of the audio. The audio can be segmented into smaller units, such as phonemes, which are matched against a database of known sounds using machine learning models trained on large amounts of speech data (as described further in FIG. 4). In other embodiments, the initial transcript 302 can be manually transcribed by a human transcriber.

A retake refers to a segment within an audio recording where the speaker repeats one or more words, phrases, or sentences multiple times in succession. This repetition can occur, for example, when the speaker makes a mistake, stumbles over words, and/or decides to rephrase a statement for clarity or emphasis. Retakes can occur in various types of audio recordings, including interviews, podcasts, voiceovers, and dictations. Identifying and removing these retakes ensures that the final text reflects the intended message without unnecessary repetitions. Methods of identifying and removing retakes are described in further detail with reference to FIG. 4.

The modified transcript (e.g., transcript B 308) is generated after applying the AI model 306 to the initial transcript 302. The AI model 306 processes the initial transcript 302 to remove the retakes, resulting in a cleaner version where repeated segments are excluded. In some embodiments, the multimedia editing platform 304 or the AI model 306 partitions the text of the initial transcript 302 into subsets, as described further in FIG. 4. The final transcript (e.g., transcript A′ 310) is a further refined version that is generated by comparing the initial transcript 302 with the modified transcript 308. Methods of generating the final transcript 310 are discussed in further detail with reference to FIG. 4.

The multimedia editing platform 304 edits and processes multimedia content, including audio files and their corresponding transcripts (e.g., initial transcript 302). For example, the multimedia editing platform 304 can receive the initial transcript 302 from a client device, apply the AI model 306 to produce the modified transcript 308, and present the modified transcript 308 to the user. In some embodiments, the multimedia editing platform 304 integrates additional features such as audio playback, text highlighting, and user annotations to allow users to interactively review and edit the transcripts. For example, final transcript 310 can be generated by the user accepting or rejecting one or more of the indicated repeated segments within the initial transcript 302.

The AI model 306 processes the initial transcript 302 to identify and remove retakes. The AI model 306 analyzes the transcript to detect identical successive segments, which are indicative of retakes. In some embodiments, the AI model 306 uses machine learning (ML) algorithms, such as recurrent neural networks (RNNs) or transformers, to accurately identify these segments, as further described in FIG. 4. In other embodiments, the AI model 306 may use rule-based systems or heuristic algorithms to detect retakes, as further described in FIG. 4. Once repetitive segments (e.g., retakes) are identified, the AI model 306 produces a modified transcript 308 where the repetitive segments are excluded. In some embodiments, the AI model 306 can be further applied to generate additional versions of the transcript based on, for example, user feedback (e.g., by approving or rejecting the indicated repeated segments within the initial transcript 302).

In the example environment 300, the initial transcript 302 is received from a client device. This transcript includes all spoken words from the audio file, including any retakes where words or phrases are repeated multiple times in succession. In some embodiments, the multimedia editing platform 304 processes this initial transcript by applying the AI model 306. The AI model 306 analyzes the transcript to identify retakes by detecting identical successive segments. Once these segments are identified, the AI model 306 produces a modified transcript 308 where the redundant segments are excluded. The multimedia editing platform 304 can generate a set of indicators to highlight the words or segments that were removed, providing a clear view of the modifications made by the AI model. These indicators can be presented on the client device, allowing the user to review and approve the changes.

FIG. 4 depicts a flow diagram of a process 400 for removing retakes in a transcript using an AI model. In one example, the process 400 is performed by a computer system such as a media production platform (e.g., the media production platform 102 in FIG. 1, the media production platform 210 in FIG. 2, the multimedia editing platform 304 in FIG. 3) to remove the retakes in the transcript. In some embodiments, the process 400 is performed by a computer system, e.g., computer system 1000 illustrated and described in more detail with reference to FIG. 10. Likewise, embodiments can include different and/or additional operations or can perform the operations in different orders.

In operation 402, the system (e.g., multimedia editing platform 304 in FIG. 3) receives, from a client device, a first transcript (e.g., initial transcript 302 in FIG. 3) that is representative of words spoken within an audio file from a client device. The client device may be any computing device capable of capturing or storing audio files, such as a smartphone, tablet, or computer. The audio file includes a retake (e.g., retakes described in FIG. 3) in which one or more words are spoken multiple times in succession, and therefore the first transcript includes a set of identical successive segments, the set of identical successive segments including a first segment that precedes a second segment.

The system can use Natural Language Processing (NLP) techniques to parse the first transcript and identify the identical successive segments. The NLP techniques can include, in some embodiments, tokenization, where the first transcript is broken down into individual words or phrases, and sequence alignment algorithms to detect repeated segments. For example, the system can preprocess the transcript by removing any extraneous characters such as punctuation marks, and/or convert the text to lowercase to ensure uniformity. The preprocessed text is split into individual tokens, which can be words or phrases. For sequence alignment, the system can use algorithms such as the Smith-Waterman algorithm or dynamic time warping (DTW) to compare segments of the transcript and identify regions of high similarity. For example, the system can create a matrix that scores the alignment of each token in the first segment with each token in the second segment, allowing the system to pinpoint exact matches or near matches, which may indicate a retake. For example, the segments “I started my company in 2010 because I saw a market need” and “I started my company in 2010” can have a high alignment score due to the repeated phrase “I started my company in 2010.” Additionally, the system can use machine learning models, such as Long Short-Term Memory (LSTM) networks or Bidirectional Encoder Representations from Transformers (BERT), to improve the accuracy of detecting repeated segments by identifying the context and semantics of the transcript. The models can be trained on a corpus of text data to recognize patterns and repetitions in natural language. For example, the segments “I started my company in 2010 because I saw a market need” and “In 2010, I founded my company to address a market need” can have a high semantic similarity because the segments convey the same meaning using different words.

In some embodiments, the system uses ASR methods, such as speech-to-text conversion algorithms to generate the first transcript from the audio file if the transcript is not already provided in text format. The speech-to-text conversion can be performed using machine learning models such as RNNs or transformer models trained on large datasets of spoken language. The training datasets can include diverse speech samples, including various accents, dialects, and speaking styles. The models can be trained by iteratively adjusting the model's weights based on the error between the predicted and actual transcripts. For RNNs, the audio data is converted into features such as Mel-frequency cepstral coefficients (MFCCs) and processed through layers of recurrent units such as Long Short-Term Memory (LSTM) or Gated Recurrent Units (GRUs), trained using backpropagation through time (BPTT). Transformer models can use an encoder-decoder structure, where the encoder processes the input audio features and the decoder generates the corresponding text, with self-attention mechanisms to handle long-range dependencies in the input sequence.

In some implementations, the system obtains a third transcript including textual content related to the audio file and partitions the third transcript into a plurality of text subsets of the textual content based on a ruleset. The first transcript can be a text subset within the plurality of text subsets. For example, the third transcript can be the same as the first transcript. The system can apply a ruleset to partition the third transcript into smaller, more manageable text subsets. The ruleset can include various criteria such as sentence boundaries, paragraph breaks, or specific keywords and phrases that denote different sections or topics within the transcript. For instance, the ruleset may use regular expressions to identify and split the text at punctuation marks like periods, question marks, and exclamation points, or at specific keywords like “Chapter,” “Section,” or “Topic.”

In some embodiments, to partition the third transcript, topic modeling algorithms like Latent Dirichlet Allocation (LDA) or clustering techniques such as k-means can be used to group sentences or paragraphs that discuss similar themes or subjects to ensure that each text subset is coherent and contextually relevant. For example, the system can identify a number of topics, where each topic is a distribution over words, and each document (or text subset) is a distribution over topics. Each sentence or paragraph is assigned to the topic with the highest probability, effectively grouping them based on thematic similarity. For k-means clustering, the system converts the text into vector representations using techniques such as TF-IDF or word embeddings like Word2Vec or BERT. The number of clusters (k) can be predefined or determined using methods like the elbow method (e.g., plotting the within-cluster sum of squares (WCSS) against various values of k and identifying the point where the rate of decrease in WCSS sharply slows down, forming an “elbow” shape) or silhouette analysis (e.g., calculating the silhouette coefficient for different values of k to identify the number of clusters that maximizes this coefficient). Each cluster represents a group of sentences or paragraphs that are similar in terms of their vector representations.

The ruleset can dynamically adjust a size of each of the plurality of text subsets based on a complexity of the textual content within the third transcript based on clause density or grammatical complexity associated with the third transcript. The clause density can be measured by dividing a total number of grammatical clauses of the textual content by a total number of words of the textual content. The system can identify clauses, phrases, and their relationships. The total number of words is counted, and the clause density is calculated as the ratio of the number of clauses to the number of words. The grammatical complexity represents a measure of syntactic variety of the textual content. For example, the system can compute a complexity score based on the frequency and variety of these syntactic features (e.g., use of subordinate clauses, passive constructions, and complex noun phrases) within the text. In some embodiments, if a segment has high clause density or high grammatical complexity, the ruleset reduces the size of the text subset by splitting the segment into smaller parts to ensure that each subset remains manageable and coherent. Conversely, if a segment has low clause density or low grammatical complexity, the ruleset increases the size of the text subset by combining adjacent segments, allowing for larger, more cohesive subsets.

In some embodiments, the ruleset dynamically adjusts a size of each of the plurality of text subsets based on positions of sentences of the textual content within the third transcript. For example, the ruleset begins each text subset of the plurality of text subsets with a beginning position of a first sentence and ends with an end position of a second sentence subsequent to the beginning position of the first sentence. The system can use punctuation marks and capitalization patterns to identify sentence boundaries. Once the sentences are identified, the system assigns a position index to each sentence, indicating its order within the transcript. The ruleset dynamically adjusts the size of each text subset by selecting a range of sentences based on their position indices. For instance, the ruleset can specify that each text subset should contain a minimum of two sentences and a maximum of five sentences, depending on the overall length and structure of the transcript. The system begins each text subset with the first sentence in the specified range and ends with the last sentence in that range. If the transcript contains sections with varying sentence lengths or structures, the ruleset can further refine the segmentation by considering additional factors such as paragraph breaks or thematic shifts.

In operation 404, the system applies, to the first transcript, an AI model (e.g., AI model 306 in FIG. 3) that produces, as output, a second transcript in which the second segment is included while the first segment is excluded. The system can supply the second transcript of the audio file into the AI model, and receive the third transcript including the second segments indicated by the one or more retakes within the first transcript. The AI model can be a deep learning model such as a convolutional neural network (CNN) to capture local patterns in data, an RNN, and/or a transformer model. For CNNs, the AI model can include multiple convolutional layers and pool the layers to reduce dimensionality of the data. For RNNs, including Long Short-Term Memory (LSTM) and Gated Recurrent Units (GRUs), the AI model can convert the transcript into a sequence of features. The AI model processes the features through its recurrent layers. For transformer models, the AI model can preprocess the transcripts into tokenized sequences and feed the transcript into the model's encoder-decoder architecture. The self-attention layers enable the model to weigh the importance of different parts of the input sequence, allowing the AI model to accurately compare and align segments from the two transcripts.

In some implementations, the AI model can be a plurality of models applied together as part of a multiple-model machine-learning framework. By integrating various models into a single framework, the framework can use the unique strengths of each to address different aspects of the transcript comparison and refinement process. For instance, one model can first capture the overall context and identify potential retakes, followed by another model to perform a comparison and alignment of segments, and a third model to fine-tune similarity measurements between segments.

In operation 406, beginning with a last word of the first transcript and the second transcript, the system iteratively compares each word of the first transcript with a corresponding word of the second transcript. The system can initialize two pointers, one for each transcript, starting at the last word of each sequence. These pointers will be used to traverse the transcripts in reverse order, from the end to the beginning. The system enters a loop where it compares the words at the current positions of the pointers in both transcripts. If the words match, the pointers are decremented to move to the previous word in each transcript. During this comparison, the system keeps track of any words in the first transcript that do not have corresponding matches in the second transcript. The system continues this iterative comparison until it reaches the first word of both transcripts, ensuring a thorough and comprehensive comparison from end to beginning. In some embodiments, the system begins in other positions of the transcript.

In operation 408, the system generates a set of indicators indicating the words of the first transcript that are absent from the second transcript. Once the comparison is complete in operation 406, the system can create a data structure, such as a list or a dictionary, to store the set of indicators. Each indicator in this set represents a word from the first transcript that is absent from the second transcript. The indicators can include additional information such as the position of the word in the first transcript, the context in which the word appears, and the nature of the discrepancy (e.g., whether the word is completely missing or replaced by a different word).

In operation 410, the system causes the set of indicators to be presented on the client device. In some embodiments, the presentation of the set of indicators on the client device includes the words of the first transcript absent from the second transcript. The system can use various methods to visually distinguish these missing words, such as color-coding, underlining, or bolding. For example, the system can display the first transcript with the missing words highlighted in red, while the second transcript is shown alongside for comparison. This visual differentiation helps users quickly identify and focus on the discrepancies. In some embodiments, the system can provide interactive features that allow users to navigate through the indicators easily. For instance, the system can include clickable links or buttons that jump to the specific locations of the missing words within the transcripts. Users can be given the option to filter the indicators based on criteria such as the type of discrepancy, the position of the missing words, or their grammatical significance.

In some embodiments, the system receives a user input associated with one or more indicators of the set of indicators. Subsequent to receiving the user input, the system removes the words of the first transcript absent from the second transcript indicated by the one or more indicators from the first transcript. For instance, if the user clicks on a highlighted word, the system records this action and identifies the associated indicator. The system retrieves the position and context of the word within the first transcript, using this information to locate the exact segment that needs to be modified.

### Applying Layouts Using an AI Model

Efficiently and accurately editing and organizing audiovisual content is often time-consuming and requires significant manual effort to identify scenes, synchronize audio and video tracks, and/or apply appropriate layouts. Another challenge lies in maintaining thematic and visual coherence throughout the audiovisual file. Editors must ensure that transitions between scenes are smooth and that the overall visual style aligns with the intended message and emotional tone of the content. The disclosed technology uses one or more AI models to detect and categorize scenes based on visual and audio cues, generate relevant layouts, and populate these layouts with the identified scenes. Further, the disclosed technology can generate and apply relevant layouts to the identified scenes, ensuring that the visual presentation is coherent and contextually aligned with the content.

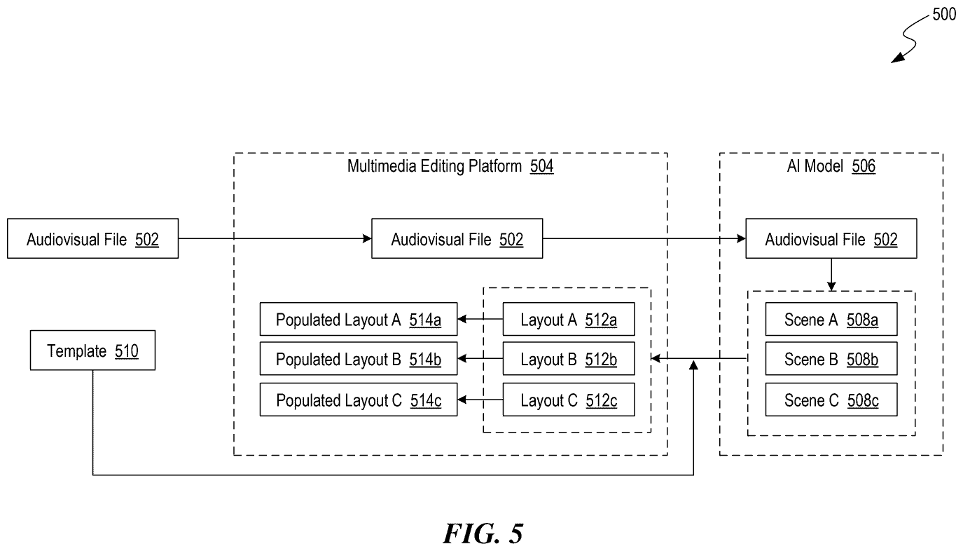

FIG. 5 is a block diagram illustrating an example environment 500 of generated layouts of an audiovisual file. The example environment 500 includes audiovisual file 502, multimedia platform 504, AI model 506, scenes 508a-c, template 510, layouts 512a-c, and populated layouts 514a-c. Multimedia editing platform 504 is the is the same as or similar to multimedia editing platform 304 illustrated and described in more detail with reference to FIG. 3. AI model 506 is the same as or similar to AI model 306 illustrated and described in more detail with reference to FIG. 3. The example environment 500 can be implemented using components of the example computer system 1000 illustrated and described in more detail with reference to FIG. 10. Likewise, embodiments of the example environment 500 can include different and/or additional components that can be connected in different ways.

The audiovisual file 502 is the raw input file that can contain audio and/or visual data. In some embodiments, the audiovisual file 502 is a video recording with synchronized audio, such as a movie, documentary, or recorded presentation. In some embodiments, the audiovisual file 502 includes separate audio and video tracks that need to be synchronized during the editing process. The audiovisual file 502 can be acquired from a client device. In some embodiments, the audiovisual file 502 may be in various formats such as MP4, AVI, or MOV. The audiovisual file 502 can include metadata such as timestamps, subtitles, and tags. The audiovisual file 502 can be input into the multimedia editing platform 504 along with a corresponding transcript, which can be input by a user or generated based on methods discussed in FIG. 3 and FIG. 4.

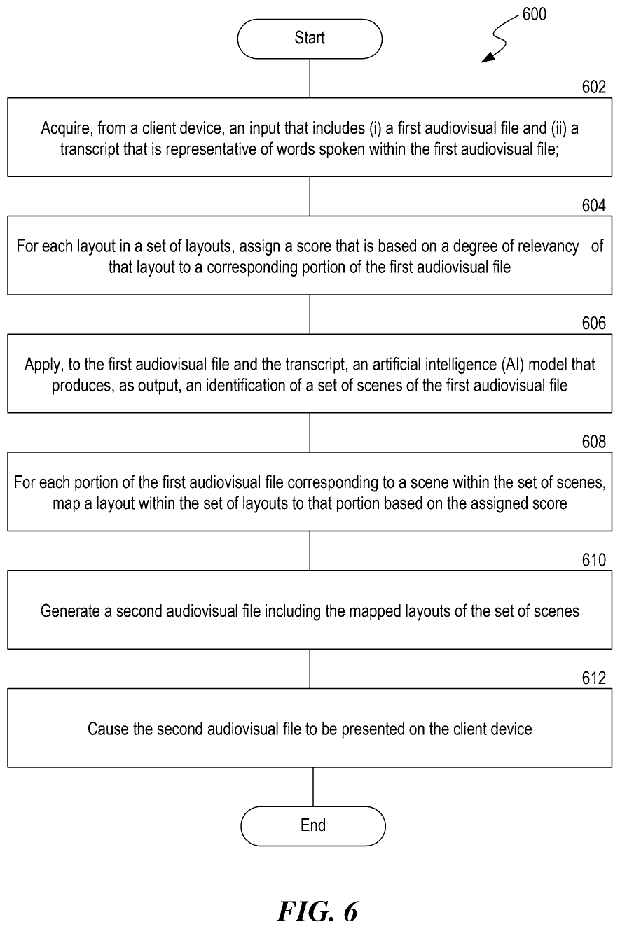

The AI model 506 can use machine learning algorithms to process the audiovisual files 502 and make intelligent suggestions or automatic edits. Examples of the AI model 506 are discussed with further reference to the AI model in FIG. 6. In some embodiments, the AI model 506 can detect scenes and/or generate additional content. In some embodiments, the AI model 506 can use CNNs for image recognition and RNNs for audio analysis.

Scenes 508a-c represent different segments or parts of the audiovisual file 502. Each scene 508a, 508b, 508c can be a distinct part of the video, such as a different location, time, or event. In some embodiments, the AI model 506 identifies and categorizes scenes 508a-c based on visual and audio cues. In some embodiments, scenes can be manually marked by the user within the multimedia platform 504. In some embodiments, scenes 508a-c may be detected based on changes in visual content, such as cuts or transitions. The scenes 508a-c can be identified based on audio cues, such as changes in speaker or background noise. The scenes 508a-c can also be annotated with metadata, such as scene descriptions or keywords.

Template 510 is a collection of predefined layouts 512a-c that can guide the AI model's 506 decisions on how to structure and format the final output (e.g., populated layouts 514a-c). Users can provide their own template, which allows for customization and control over the style and presentation of the edited content. If users do not provide specific templates, the system can use a predefined collection of default layouts in a default template. Each template 510 consists of multiple layouts, each designed for different types of scenes or content segments. For example, a template can include layouts for interviews, product demonstrations, social media clips, and presentations. The AI model 506 evaluates the content of each scene 508a-c detected within the audiovisual file 502 and ranks the available layouts based on their relevance and suitability for that particular scene. The highest-ranked layout can be selected and applied to the scene.

In addition to the predefined layouts, the template 510 can incorporate user-defined styles that influence not only the choice of layouts but also how scenes 508a-c are detected and segmented. The styles can represent semantic concepts such as “Product Demo,” “Podcast,” “Presentation,” “Montage,” and “Social Media Clip.” Each template 510 can include internal predefined rules that guide the AI model's decisions on scene creation and layout ranking. In some embodiments, the template 510 can include parameters (e.g., user defined, default) that are adjustable to further refine the editing process. For example, users can specify, using the template 510 parameters, the target duration of the final video, the frequency of cuts between different scenes, and/or the sources of additional footage or images. In some embodiments, the adjustable parameters include options for sourcing additional footage, such as from stock video providers, stock image providers, AI-generated images (with prompts), and/or user-uploaded media. The template 510 parameters can ensure that the supplementary content aligns with the intended overall theme. Additionally, users can define the tone for any text to be filled in within some layouts, such as captions, titles, or descriptions. For example, a template parameter can instruct a formal tone for corporate presentations or a casual tone for social media clips. If the AI model 506 is used to determine layouts 512a-c, the template 510 parameters are input into the AI model 506. The parameters provide additional control over the final product, allowing users to fine-tune the editing process to achieve their desired outcome.

Layouts 512a-c are predefined structures that dictate how the audiovisual content should be arranged. Each layout 512a, 512b, 512c can have a different design or format, suitable for various types of presentations or outputs. In some embodiments, layouts 512a-c include placeholders for video clips, images, text, and other multimedia elements. In other embodiments, layouts 512a-c are dynamically generated based on the content and user preferences. The layouts 512a-c organize and present the audiovisual content in a coherent and visually appealing manner. In some embodiments, layouts 512a-c are designed for specific purposes, such as social media posts, presentations, or advertisements, while in other embodiments, layouts 512a-c are customizable by the user to fit specific needs. The layouts 512a-c can include predefined transitions and effects to enhance the visual appeal of the final output (e.g., populated layouts 512a-c).

Populated layouts 514a-c are the final outputs where the audiovisual file 502 has been placed into the corresponding layouts 512a-c. The AI model 506 can assist in populating the layouts 512a-c by selecting the appropriate scenes and arranging them according to the chosen structure. In some embodiments, the populated layouts 514a-c include additional enhancements such as transitions, effects, and annotations. In some embodiments, the populated layouts 514a-c are formatted for specific platforms.

In the example environment 500, the audiovisual file 502 is received from a client device. The multimedia platform 504 integrates the audiovisual file 502 with the AI model 506 to identify different scenes 508a, 508b, and 508c. In some embodiments, the AI model 506 uses machine learning algorithms to detect scenes based on visual and audio cues, such as changes in lighting, color, or sound. In other embodiments, scenes 508a-c are manually marked by the user within the multimedia platform 504. The AI model 506 can use techniques such as CNNs for image recognition and/or RNNs for audio analysis. Once the scenes are identified, the multimedia platform 504 applies layouts 512a, 512b, and 512c to the identified scenes 508a-c. In some embodiments, these layouts are structures with placeholders for video clips, images, text, and other multimedia elements. In other embodiments, layouts may be dynamically generated based on the content and user preferences. The AI model 506 can, in some embodiments, populate the layouts 512a-c by selecting the appropriate scenes and arranging them according to the chosen layout structure. In some embodiments, the populated layouts 514a-c may be exported in various formats for different applications and media.

FIG. 6 depicts a flow diagram of a process 600 for generating layouts for an audiovisual file using an AI model. In one example, the process 600 is performed by a computer system such as a media production platform (e.g., the media production platform 102 in FIG. 1, the media production platform 210 in FIG. 2, the multimedia editing platform 504 in FIG. 5) to generate the layouts for the audiovisual file. In some embodiments, the process 600 is performed by a computer system, e.g., computer system 1000 illustrated and described in more detail with reference to FIG. 10. Likewise, embodiments can include different and/or additional operations or can perform the operations in different orders.

In operation 602, the system (e.g., multimedia editing platform 504 in FIG. 5) acquires, from a client device, an input that includes (i) a first audiovisual file (e.g., audiovisual file 502 in FIG. 5) and (ii) a transcript that is representative of words spoken within the first audiovisual file. For example, the system can prompt the user to upload the first audiovisual file and/or the transcript. Methods of generating a transcript from an audiovisual file are discussed with reference to FIG. 3 and FIG. 4.

In operation 604, for each layout in a set of layouts, the system assigns a score that is based on a degree of relevancy of that layout to a corresponding portion of the first audiovisual file. The degree of relevancy refers to the extent to which a particular layout aligns with and enhances the content, context, and intended message of a corresponding portion of an audiovisual file. The degree of relevancy can consider various dimensions, including visual congruence, thematic consistency, emotional resonance, and contextual appropriateness. Visual congruence involves matching the layout's color schemes, typography, and graphical elements with the visual aesthetics of the audiovisual segment. Thematic consistency ensures that the layout's design elements and overall style are in harmony with the themes and subjects discussed in the segment. Emotional resonance pertains to the layout's ability to evoke the intended emotional response, whether it be excitement, calmness, or seriousness, in alignment with the audiovisual content. Contextual appropriateness involves the layout's suitability for the specific context, such as matching the tone of the spoken words or the nature of the visual scenes. In some embodiments, the degree of relevancy of the layout to the corresponding portion of the first audiovisual file is higher when the corresponding words of the transcript match words indicated within the layout.

The system can first define a set of criteria or features that determine the relevancy of a layout. The criteria can include visual elements such as color schemes, text placement, and graphical components, as well as contextual elements such as thematic consistency, emotional tone, and alignment with the spoken words or visual scenes in the audiovisual file. The first audiovisual file can be analyzed to extract relevant features, which can include visual features (e.g., dominant colors, objects detected in the scene), audio features (e.g., speech content, background music), and textual features (e.g., transcript of spoken words).

For each layout in the set of layouts, the system computes a relevancy score by comparing the features of the layout with the features of the corresponding portion of the audiovisual file. This comparison can be done using various techniques, such as feature matching, where the system can use similarity measures such as cosine similarity, Euclidean distance, or Jaccard index to compare the feature vectors of the layout and the audiovisual segment. For example, if the layout has a specific color scheme, the system can compare it with the dominant colors in the audiovisual segment to determine the degree of match. In some embodiments, the system can train machine learning models, such as support vector machines (SVM), random forests, or neural networks, to predict the relevancy score based on labeled training data. The training data consists of pairs of layouts and audiovisual segments with known relevancy scores. The model learns to predict the score based on the extracted features. For textual features, the system can use NLP techniques such as sentiment analysis, topic modeling, or semantic similarity to compare the transcript of the audiovisual segment with the textual content or annotations of the layout. This helps in determining how well the layout aligns with the spoken words or themes in the segment.

Once the relevancy scores are computed for each layout, the system can rank the layouts based on their scores. The highest-scoring layouts are considered the most relevant to the corresponding portions of the audiovisual file. These scores can be used to automatically select the best layout for each segment, or they can be presented to users for manual review and selection. In some embodiments, the system receives a user input, via the client device, indicating a new layout. The system adds the new layout to the set of layouts.

In some embodiments, the set of scenes is a first set of scenes. The system can receive, from the AI model, a second set of scenes of the first audiovisual file, where each scene in the second set of scenes includes a plurality of scenes from the first set of scenes. For example, the system preprocesses the first audiovisual file to segment it into corresponding portions. This segmentation can be based on various factors such as scene changes, speaker transitions, or predefined time intervals.

In operation 606, the system applies, to the first audiovisual file and the transcript, an AI model that produces, as output, an identification of a set of scenes of the first audiovisual file. Each scene in the set of scenes is a portion of the first audiovisual file. In some embodiments, each identified scene is a portion of the audiovisual file that is coherent and self-contained, representing a specific event, location, or theme. The system assigns timestamps or frame indices to each scene, indicating the start and end points within the audiovisual file.

The system can evaluate the audiovisual file and the transcript to extract relevant features that can be used for scene identification. These features can include visual cues (e.g., changes in lighting, color, or objects), audio cues (e.g., changes in background music, sound effects, or speaker transitions), and textual cues (e.g., changes in topics or keywords in the transcript). The AI model can use CNNs or other deep learning models to detect changes in visual content, such as scene transitions, camera cuts, or significant changes in the visual composition. In some implementations, the AI model can use RNNs or other sequence-based models to detect changes in audio patterns, such as shifts in background music, sound effects, or speaker changes. For example, the CNNs can analyze the visual content of audiovisual files 502, detecting changes in scenes, lighting, and other visual cues to segment the video into distinct clips. For example, features that indicate a change in the visual content can include sudden changes in pixel intensity, color histograms, or edge distributions between consecutive frames. A CNN can be trained to recognize these features by analyzing frame differences and identifying patterns that correspond to scene transitions or cuts. For instance, a significant change in the color histogram between two frames can indicate a scene change, while a sudden shift in edge distribution could signal a cut. The RNNs can identify shifts in speaker, background noise, and other audio patterns. For example, changes in background noise or the occurrence of specific sound events, such as a door closing or a phone ringing, can be identified based on the temporal dependencies captured by models trained on a labeled dataset where changes in audio content, such as speaker transitions and background noise variations, are annotated.

In some implementations, the AI model can use NLP models like BERT or GPT to analyze the transcript and detect changes in topics, keywords, or dialogue patterns. The AI model can be trained on a labeled dataset of audiovisual files with segmented scenes, allowing it to learn patterns and criteria for scene segmentation. During inference, the model uses these learned patterns to segment the input audiovisual file into a set of scenes.

In operation 608, for each portion of the first audiovisual file corresponding to a scene within the set of scenes, the system maps a layout within the set of layouts to that portion based on the assigned score In operation 610, the system. The system can iterate through each scene in the set of scenes. In some embodiments, mapping the layout within the set of layouts to the portion based on the assigned score is based on a predefined order of the set of layouts. For each scene, it accesses the list of layouts and their associated relevancy scores. The system compares the scores to identify the layout with the highest score for that specific scene and assign the selected layout to the scene.

To ensure a coherent visual experience, the system can consider additional factors such as the overall visual style and thematic consistency across scenes. For example, if adjacent scenes have similar themes or visual elements, the system may choose layouts that are similar to maintain a cohesive look and feel throughout the audiovisual file. Once the mapping is complete, the system can store the associations between scenes and layouts in a structured format, such as a database or a metadata file.

In some embodiments, mapping the layout within the set of layouts is based on a cooldown parameter associated with the layout, where the cooldown parameter is expired. The cooldown parameter can be a mechanism to prevent the overuse of a particular layout within a short time frame, ensuring visual diversity and preventing viewer fatigue. When a layout is applied to a scene, the layout enters a cooldown period during which the layout cannot be reused for subsequent scenes. This cooldown period is defined by a specific duration or number of scenes. The system tracks the cooldown status of each layout and only considers layouts with expired cooldown parameters for mapping to new scenes. This ensures that layouts are rotated and reused in a balanced manner, promoting a varied and engaging visual experience. For example, if a layout has a cooldown period of three scenes, it will not be eligible for selection until three other scenes have been processed. By incorporating the cooldown parameter, the system enhances the aesthetic appeal and maintains viewer interest by avoiding repetitive visual patterns.

In some embodiments, the system receives, from the AI model, a set of keywords of each scene in the set of scenes representative of the words within the corresponding scene. Mapping the layout within the set of layouts can be based on the set of keywords for the corresponding scene extracted from, for example, the transcript. The system can use the keywords to inform the layout mapping process by matching the thematic content of the scene with the most relevant layout. For instance, if a scene's keywords include terms like “innovation,” “technology,” and “future,” the system can select a layout that visually emphasizes modernity and uses sleek design elements and futuristic graphics to ensure that the visual presentation is contextually aligned with the content of the scene.

In some implementations, the AI model can be a plurality of models applied together as part of a multiple-model machine-learning framework. By integrating various models, the framework can use the unique strengths of each to address different aspects of the transcript comparison and refinement process. For instance, one model could first analyze the overall context and structure of the audiovisual file, followed by another model to perform segmentation and alignment of scenes, and finally, a third model to fine-tune the coherence and self-contained nature of each identified scene.

In operation 610, the system generates a second audiovisual file including the mapped layouts of the set of scenes. Once all scenes have been processed and the layouts have been integrated, the system compiles and renders the second audiovisual file, producing an output that combines the original audiovisual file and/or transcript with the enhanced visual elements. In operation 612, the system causes the second audiovisual file to be presented on the client device.

### Generating Highlight Clips Using an AI Model

Efficiently identifying and generating highlight clips from an audiovisual file is a task that traditionally requires extensive manual effort and expertise. In conventional workflows, editors must painstakingly review hours of footage to pinpoint highlight moments, a process that is both time-consuming and prone to human error. Additionally, the need to categorize and prioritize the clips based on thematic relevance further complicates the editing process, making it challenging to produce coherent and engaging highlight reels. The disclosed technology uses one or more AI models to analyze the audiovisual file to detect distinct segments based on visual and audio cues, such as changes in lighting, color, sound, or speaker transitions. By assigning scores to clips based on their relevance to identified topics, the disclosed technology can prioritize the most significant segments, streamlining the editing process and producing high-quality highlight reels that effectively capture the essence of the original content. The disclosed technology not only presents users with the best clips but also displays the scores and provides reasoning to explain these scores. Transparency in the scoring process can help users understand why particular clips were selected, thereby increasing their confidence in the selection process and allowing users to make more informed decisions.

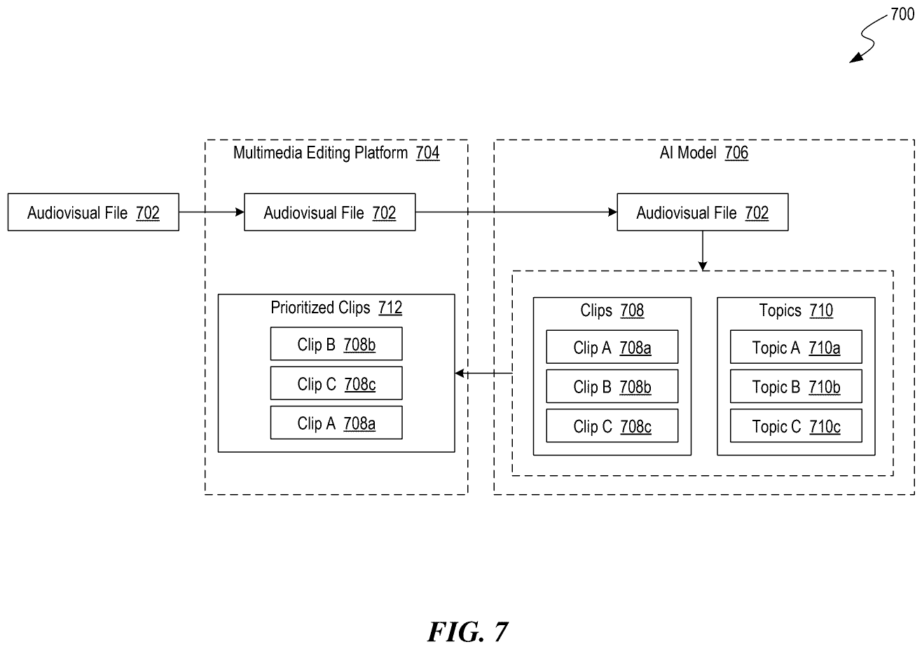

FIG. 7 is a block diagram illustrating an example environment 700 of generated highlight clips of an audiovisual file. The example environment 700 includes audiovisual file 702, multimedia editing platform 704, AI model 706, clips 708a-c, topics 710a-c, and prioritized clips 712. Audiovisual file 702 is the same as or similar to audiovisual file 502 illustrated and described in more detail with reference to FIG. 5. Multimedia editing platform 704 is the is the same as or similar to multimedia editing platform 304 and multimedia editing platform 504 illustrated and described in more detail with reference to FIG. 3 and FIG. 5, respectively. AI model 706 is the same as or similar to AI model 306 and AI model 506 illustrated and described in more detail with reference to FIG. 3 and FIG. 5, respectively. The example environment 700 can be implemented using components of the example computer system 1000 illustrated and described in more detail with reference to FIG. 10. Likewise, embodiments of the example environment 700 can include different and/or additional components that can be connected in different ways.

Clips 708a-c are segments extracted from the original audiovisual file. Each clip represents a distinct portion of the content, which can be individually edited or rearranged. In some embodiments, the AI model 706 identifies and categorizes clips 708a-c based on visual and audio cues. In other embodiments, the clips 708a-c may be manually marked by the user within the multimedia platform 704. In some embodiments, clips 708a-c are detected based on changes in visual content, such as cuts or transitions, while additionally or alternatively, clips 708a-c are identified based on audio cues, such as changes in speaker or background noise. The clips 708a-c may also be annotated with metadata, such as scene descriptions or keywords. Additionally, in some embodiments, the clips 708a-c can be automatically tagged with relevant information such as timestamps, speaker identification, and scene context, while in other embodiments, users can manually add tags and annotations to enhance the organization and retrieval of clips 708a-c.

Topics 710a-c are thematic categories or subjects identified within the audiovisual file 702. Each topic 710a, 710b, and 710c corresponds to specific content within the clips 708a-c, and classifies the material within the audiovisual file 702 based on thematic relevance. In some embodiments, the AI model 706 uses NLP techniques to identify topics based on the transcript of the audiovisual file 702. In other embodiments, topics 710a-c may be manually assigned by the user within the multimedia platform 704. In some embodiments, topics 710a-c may be identified based on keywords or phrases within the transcript. Topics 710a-c can be determined based on the overall context or subject matter of the clips. Additionally, in some embodiments, topics 710a-c can be dynamically updated as new content is added or edited, while additionally or alternatively, topics 710a-c can be predefined categories that users can select from a list.

Prioritized clips 712 are clips that have been ranked or selected based on their importance or relevance, as determined by the AI model 706 or user preferences. Prioritization helps streamline the editing process by focusing on the most significant segments of the audiovisual file. In some embodiments, the AI model 706 assigns a score to each clip based on its relevance to the identified topics. In other embodiments, prioritization may be based on user-defined criteria, such as the length of the clip or its position within the audiovisual file. In yet another embodiment, the AI model 706 is a set of models operating under a single framework. For example, separate AI models are employed for generating clips and for scoring/ranking the clips into prioritized clips 712. In some embodiments, the AI model 706 can contain a hierarchical structure, where a set of specialized models, acting as agents, operate under the guidance of a central controlling model. Each agent model is designed to perform specific tasks, such as generating clips, scoring the clips, or ranking the clips. The controlling model can orchestrate the activities of the agent models, or use the agent models to cross-validate one another (e.g., using multiple models to score the clips, and taking the average score of each clip).

In some embodiments, the AI model 706 can be continuously improved by incorporating actual user feedback. For example, users can provide thumbs up/down feedback, and the system can track which clips are accepted (i.e., exported) or rejected (either explicitly by deleting them or implicitly by not exporting them). The information can then be used to adjust the AI model's 706 algorithms and parameters so the AI model 706 can generate and rank clips that align more closely with the feedback. Over time, as more feedback is collected, the AI model 706 becomes increasingly adept at producing relevant and high-quality clips, resulting in a more personalized and satisfying user experience.

The prioritized clips 712 represent the segments to be included in the final edited content. In some embodiments, the prioritized clips can be highlighted or marked within the multimedia platform 704 to facilitate identification and selection during the editing process. Additionally, in some embodiments, the prioritization may be dynamically adjusted based on user feedback or changes in the content, while in other embodiments, it may be based on predefined rules and algorithms.

In the example environment 700, the initial audiovisual file 702 is received from a client device. The AI model 706 analyzes the audiovisual file 702 to identify different clips 708a, 708b, and 708c. In some embodiments, the AI model 706 uses machine learning algorithms to detect clips based on visual and audio cues, such as changes in lighting, color, or sound. In other embodiments, clips 708a-c may be manually marked by the user within the multimedia platform 704. The AI model 706 may use techniques such as CNNs for image recognition and RNNs for audio analysis. Once the clips are identified, the AI model 706 can use clustering algorithms to group similar clips together, while in other embodiments, the AI model 706 may employ sequence alignment techniques to ensure continuity and coherence in the final edited content. The multimedia editing platform 704 applies topics 710a-c to the identified clips. In some embodiments, the topics 710a-c are thematic categories or subjects identified within the audiovisual file. In other embodiments, topics 710a-c may be manually assigned by the user within the multimedia platform 704. The AI model 706 assists in mapping topics 710a-c to the clips by selecting the appropriate segments and arranging them according to the chosen layout. This results in prioritized clips 712, which can be exported in various formats for different applications and media. Additionally, in some embodiments, the multimedia editing platform 704 may offer preview and review functionalities to allow users to make final adjustments before exporting the content, while in other embodiments, the multimedia editing platform 704 may include automated quality checks to ensure the final output meets specific standards and requirements.

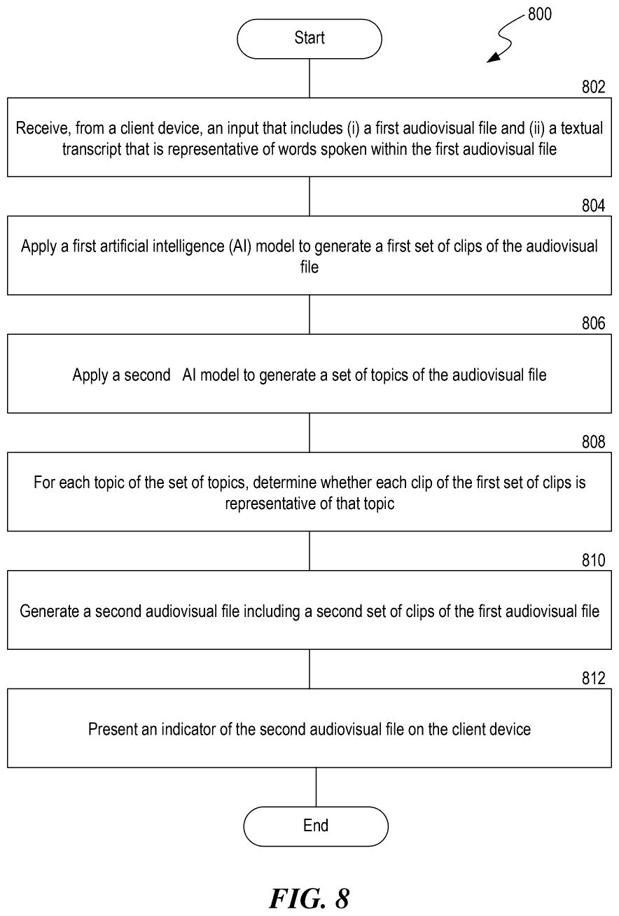

FIG. 8 depicts a flow diagram of a process 800 for generating highlight clips of an audiovisual file using an AI model. In one example, the process 800 is performed by a computer system such as a media production platform (e.g., the media production platform 102 in FIG. 1, the media production platform 210 in FIG. 2, the multimedia editing platform 704 in FIG. 7) to generate the highlight clips of the audiovisual file. In some embodiments, the process 800 is performed by a computer system, e.g., computer system 1000 illustrated and described in more detail with reference to FIG. 10. Likewise, embodiments can include different and/or additional operations or can perform the operations in different orders.

In operation 802, the system (e.g., multimedia editing platform 704 in FIG. 7) receives, from a client device, an input that includes (i) a first audiovisual file and (ii) a textual transcript that is representative of words spoken within the first audiovisual file. The received audiovisual file and/or textual transcript can be the same as or similar to the audiovisual file and/or textual transcript described with reference to FIG. 6.

In operation 804, the system applies a first AI model to generate a first set of clips of the audiovisual file. The system supplies the first audiovisual file and the textual transcript into the first AI model. The system receives, from the first AI model, the first set of clips of the first audiovisual file. Each clip in the first set of clips can be a portion of the first audiovisual file. The AI model can be trained on large datasets of audiovisual content and their corresponding transcripts to identify logical segments within the audiovisual file based on various cues such as changes in visual scenes, shifts in audio patterns, and transitions in the spoken content as indicated by the transcript. The AI model can detect and delineate distinct portions of the audiovisual file that represent coherent units of content, such as individual scenes, topics, or events.

In some embodiments, each clip in the first set of clips has a length below a predetermined threshold. The predetermined threshold can be determined from, for example, a received user input. The predetermined length can vary depending on the specific requirements of the project, such as the intended use of the clips, the nature of the content, and the desired level of detail. For instance, in a marketing video, shorter clips (e.g., a shorter predetermined length) can be desired to maintain viewer engagement and deliver key messages quickly, whereas in a documentary, longer clips (e.g., a longer predetermined length) can be desired to preserve the narrative flow. By enforcing a maximum clip length, the system ensures that each segment remains digestible and relevant, avoiding overly lengthy or unwieldy portions that could complicate the editing process.

In operation 806, the system applies a second AI model to generate a set of topics of the audiovisual file. The system supplies the first audiovisual file and the textual transcript into the second AI model. The system receives, from the second AI model, the set of topics of the first audiovisual file. Each topic in the set of topics can be associated with one or more portions of the first audiovisual file. For example, a topic related to “sustainability” can be linked to several segments where environmental issues are discussed, while a topic on “innovation” could correspond to parts of the file highlighting new technologies. This topic-based segmentation allows for more targeted and contextually relevant editing, enabling the system to apply specific enhancements, annotations, or visual elements that align with the identified themes. By organizing the content around these key topics, the system improves the coherence and narrative flow of the final product, making it more engaging and informative for the audience.

In some implementations, the first and/or the second AI model can be a plurality of models applied together as part of a multiple-model machine-learning framework. By integrating various models, the framework can use the unique strengths of each to address different aspects of the transcript comparison and refinement process. For instance, one model could first analyze the overall context and structure of the audiovisual file, followed by another model to determine the set of clips/topics, and finally, a third model to fine-tune the set of clips/topics.

In operation 808, for each topic of the set of topics, the system determines whether each clip of the first set of clips is representative of that topic. The system can cross-reference the thematic content identified by the second AI model with the segmented clips generated by the first AI model. The system can use keyword matching, semantic analysis, and contextual understanding, to evaluate the relevance of each clip to the identified topics. For instance, if a topic is centered around “sustainability,” the system can analyze the transcript and audiovisual content of each clip to identify mentions of related terms, concepts, and visual cues, such as discussions on renewable energy, environmental policies, or green technologies. Clips that contain a high density of these relevant elements can be flagged as representative of the “sustainability” topic.

In operation 810, the system generates a second audiovisual file including a second set of clips of the first audiovisual file. Each clip within the second set of clips is representative of at least one topic of the set of topics. The system selects clips from the first set that have been identified as relevant to the various topics determined in operation 808. The selected clips are organized and sequenced in a manner that enhances the narrative flow and thematic coherence of the second audiovisual file. The system can apply additional editing techniques, such as trimming, merging, or adding transitions, to refine the clips and enhance the overall viewing experience.

In some embodiments, for each clip of the first set of clips, the system assigns a score based on whether each clip of the first set of clips is representative of the topic of the set of topics. The second set of clips can include clips of the first set of clips with an assigned score above a threshold score. This scoring process involves evaluating the content of each clip against the identified topics using various metrics such as keyword frequency, semantic relevance, and contextual alignment. The system assigns higher scores to clips that exhibit a strong correlation with the topics. For instance, a clip discussing renewable energy in detail would receive a higher score for the “sustainability” topic compared to a clip with only a brief mention. Once all clips are scored, the system applies a threshold score to filter out less relevant clips, ensuring that only those with scores above the threshold are included in the second set of clips. This threshold-based selection process ensures that the final compilation is composed of the most relevant and impactful segments, enhancing the thematic coherence and overall quality of the second audiovisual file.

In some embodiments, the second set of clips is determined based on a prioritized order of the first set of clips, where the prioritized order of the first set of clips is determined based on the assigned score of each clip of the first set of clips. After scoring each clip for its relevance to the identified topics, the system ranks the clips in descending order of their scores, effectively creating a prioritized list that highlights the most thematically significant segments at the top. This prioritization ensures that the most relevant and impactful clips are given precedence in the final compilation. The system selects clips from this ordered list to form the second set, ensuring that the highest-scoring clips are included first.

In operation 812, the system presents an indicator of the second audiovisual file on the client device. In some embodiments, the system displays, via an interface, a first graphical representation including the second set of clips of the first audiovisual file, and a second graphical representation including the first audiovisual file. In some embodiments, the system displays, via an interface, the second audiovisual file.

### AI System

FIG. 9 is a high-level block diagram illustrating an example AI system, in accordance with one or more embodiments. The AI system 900 is implemented using components of the example computer system 1000 illustrated and described in more detail with reference to FIG. 10. Likewise, embodiments of the AI system 900 include different and/or additional components or be connected in different ways.

In some embodiments, as shown in FIG. 9, the AI system 900 includes a set of layers, which conceptually organize elements within an example network topology for the AI system's architecture to implement a particular AI model 930. Generally, an AI model 930 is a computer-executable program implemented by the AI system 900 that analyses data to make predictions. Information passes through each layer of the AI system 900 to generate outputs for the AI model 930. The layers include a data layer 902, a structure layer 904, a model layer 906, and an application layer 908. The algorithm 916 of the structure layer 904 and the model structure 920 and model parameters 922 of the model layer 906 together form the example AI model 930. The optimizer 926, loss function engine 924, and regularization engine 928 work to refine and optimize the AI model 930, and the data layer 902 provides resources and support for the application of the AI model 930 by the application layer 908.

The data layer 902 acts as the foundation of the AI system 900 by preparing data for the AI model 930. As shown, in some embodiments, the data layer 902 includes two sub-layers: a hardware platform 910 and one or more software libraries 912. The hardware platform 910 is designed to perform operations for the AI model 930 and includes computing resources for storage, memory, logic, and networking, such as the resources described in relation to FIGS. 1-8. The hardware platform 910 processes amounts of data using one or more servers. The servers can perform backend operations such as matrix calculations, parallel calculations, machine learning (ML) training, and the like. Examples of servers used by the hardware platform 910 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 910 includes Infrastructure as a Service (IaaS) resources, which are computing resources, (e.g., servers, memory, etc.) offered by a cloud services provider. In some embodiments, the hardware platform 910 includes computer memory for storing data about the AI model 930, application of the AI model 930, and training data for the AI model 930. In some embodiments, the computer memory is a form of random-access memory (RAM), such as dynamic RAM, static RAM, and non-volatile RAM.

In some embodiments, the software libraries 912 are thought of as suites of data and programming code, including executables, used to control the computing resources of the hardware platform 910. In some embodiments, the programming code includes low-level primitives (e.g., fundamental language elements) that form the foundation of one or more low-level programming languages, such that servers of the hardware platform 910 can use the low-level primitives to carry out specific operations. The low-level programming languages do not require much, if any, abstraction from a computing resource's instruction set architecture, allowing them to run quickly with a small memory footprint. Examples of software libraries 912 that can be included in the AI system 900 include Intel Math Kernel Library, Nvidia cuDNN, Eigen, and Open BLAS.

In some embodiments, the structure layer 904 includes an ML framework 914 and an algorithm 916. The ML framework 914 can be thought of as an interface, library, or tool that allows users to build and deploy the AI model 980. In some embodiments, the ML framework 914 includes an open-source library, an application programming interface (API), a gradient-boosting library, an ensemble method, and/or a deep learning toolkit that works with the layers of the AI system facilitate development of the AI model 930. For example, the ML framework 914 distributes processes for the application or training of the AI model 930 across multiple resources in the hardware platform 910. In some embodiments, the ML framework 914 also includes a set of pre-built components that have the functionality to implement and train the AI model 930 and allow users to use pre-built functions and classes to construct and train the AI model 930. Thus, the ML framework 914 can be used to facilitate data engineering, development, hyperparameter tuning, testing, and training for the AI model 930. Examples of ML frameworks 914 that can be used in the AI system 900 include TENSORFLOW, PYTORCH, SCIKIT-LEARN, KERAS, CAFFE, LIGHTGBM, RANDOM FOREST, and AMAZON WEB SERVICES.

In some embodiments, the algorithm 916 is an organized set of computer-executable operations used to generate output data from a set of input data and can be described using pseudocode. In some embodiments, the algorithm 916 includes complex code that allows the computing resources to learn from new input data and create new/modified outputs based on what was learned. In some embodiments, the algorithm 916 builds the AI model 930 through being trained while running computing resources of the hardware platform 910. The training allows the algorithm 916 to make predictions or decisions without being explicitly programmed to do so. Once trained, the algorithm 916 runs at the computing resources as part of the AI model 930 to make predictions or decisions, improve computing resource performance, or perform tasks. The algorithm 916 is trained using supervised learning, unsupervised learning, semi-supervised learning, and/or reinforcement learning. The application layer 908 describes how the AI system 900 is used to solve problems or perform tasks.

As an example, to train an AI model 930 that is intended to model human language (also referred to as a language model), the data layer 902 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 902 is annotated with ground truth labels (e.g., each data entry in the training dataset is paired with a label), or unlabeled.

Training an AI model 930 generally involves inputting into an AI model 930 (e.g., an untrained ML model) data layer 902 to be processed by the AI model 930, processing the data layer 902 using the AI model 930, collecting the output generated by the AI model 930 (e.g., based on the inputted training data), and comparing the output to a desired set of target values. If the data layer 902 is labeled, the desired target values, in some embodiments, are, e.g., the ground truth labels of the data layer 902. If the data layer 902 is unlabeled, the desired target value is, in some embodiments, a reconstructed (or otherwise processed) version of the corresponding AI model 930 input (e.g., in the case of an autoencoder), or is a measure of some target observable effect on the environment (e.g., in the case of a reinforcement learning agent). The parameters of the AI model 930 are updated based on a difference between the generated output value and the desired target value. For example, if the value outputted by the AI model 930 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 930 typically is to minimize a loss function or maximize a reward function.

In some embodiments, the data layer 902 is a subset of a larger data set. For example, a data set is split into three mutually exclusive subsets: a training set, a validation (or cross-validation) set, and a testing set. The three subsets of data, in some embodiments, are used sequentially during AI model 930 training. For example, the training set is first used to train one or more ML models, each AI model 930, e.g., having a particular architecture, having a particular training procedure, being describable by a set of model hyperparameters, and/or otherwise being varied from the other of the one or more ML models. The validation (or cross-validation) set, in some embodiments, is used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 930. Backpropagation is used to adjust (also referred to as update) the value of the parameters in the AI model 930, with the goal of optimizing the objective function. For example, a defined loss function is calculated by forward propagation of an input to obtain an output of the AI model 930 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 930 are used. The process of updating (or learning) the parameters over many iterations is referred to as training. In some embodiments, training is carried out iteratively until a convergence condition is met (e.g., a predefined maximum number of iterations has been performed, or the value outputted by the AI model 930 is sufficiently converged with the desired target value), after which the AI model 930 is considered to be sufficiently trained. The values of the learned parameters are fixed and the AI model 930 is deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 930 typically involves further training the ML model on a number of data samples (which may be smaller in number/cardinality than those used to train the model initially) that closely target the specific task. For example, an AI model 930 for generating natural language that has been trained generically on publicly available text corpora is, e.g., fine-tuned by further training using specific training samples. In some embodiments, the specific training samples are used to generate language in a certain style or a certain format. For example, the AI model 930 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some embodiments, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

### Computing Platform

FIG. 10 is a block diagram illustrating an example computer system 1000, in accordance with one or more embodiments. In some embodiments, components of the example computer system 1000 are used to implement the software platforms described herein. At least some operations described herein can be implemented on the computer system 1000.

In some embodiments, the computer system 1000 includes one or more central processing units (“processors”) 1002, main memory 1006, non-volatile memory 1010, network adapters 1012 (e.g., network interface), video displays 1018, input/output devices 1020, control devices 1022 (e.g., keyboard and pointing devices), drive units 1024 including a storage medium 1026, and a signal generation device 1020 that are communicatively connected to a bus 1016. The bus 1016 is illustrated as an abstraction that represents one or more physical buses and/or point-to-point connections that are connected by appropriate bridges, adapters, or controllers. The bus 1016, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1094 bus (also referred to as “Firewire”).

In some embodiments, the computer system 1000 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1000.

While the main memory 1006, non-volatile memory 1010, and storage medium 1026 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1028. The term “machine-readable medium” and “storage medium” shall also be taken to include any medium that is capable of storing, encoding, or carrying a set of instructions for execution by the computer system 1000. In some embodiments, the non-volatile memory 1010 or the storage medium 1026 is a non-transitory, computer-readable storage medium storing computer instructions, which is executable by one or more “processors” 1002 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1004, 1008, 1028) set at various times in various memory and storage devices in a computer device. When read and executed by one or more processors 1002, the instruction(s) cause the computer system 1000 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1010, floppy and other removable disks, hard disk drives, optical discs (e.g., compact disc read-only memory (CD-ROMS), digital versatile discs (DVDs)), and transmission-type media such as digital and analog communication links.

The network adapter 1012 enables the computer system 1000 to mediate data in a network 1014 with an entity that is external to the computer system 1000 through any communication protocol supported by the computer system 1000 and the external entity. The network adapter 1012 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1012 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 900 illustrated and described in more detail with reference to FIG. 9.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the art to understand the claimed subject matter, the various embodiments, and the various modifications that are suited to the particular uses that are contemplated.

Although the Detailed Description describes various embodiments, the technology can be practiced in many ways no matter how detailed the Detailed Description appears. Embodiments may vary considerably in their embodiment details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method for editing multimedia content, the method comprising:
receiving, from a client device, input that is indicative of a request to edit a first content,
wherein the first content includes one or more of: (i) a first audiovisual file or (ii) a transcript that is representative of words spoken within the first audiovisual file;
applying a neural network to (i) the first content and (ii) a pre-loaded query context related to the request to edit the first content, the neural network being trained to produce, as output, a second content in accordance with the pre-loaded query context;
determining, based on an analysis of the first content, whether the second content is responsive to the request to edit the first content;
generating a second audiovisual file including a third content,
wherein the third content includes one or more portions of the second content that is responsive to the request to edit the first content; and
transmitting, to the client device, the second content for presentation to an individual.

2. A method for removing retakes of a transcript, the method comprising:
receiving, from a client device, a first transcript that is representative of words spoken within an audio file from a client device,
wherein the audio file includes a retake in which one or more words are spoken multiple times in succession, and therefore the first transcript includes a set of identical successive segments, the set of identical successive segments including a first segment that precedes a second segment;
applying, to the first transcript, an artificial intelligence (AI) model that produces, as output, a second transcript in which the second segment is included while the first segment is excluded;
beginning with a last word of the first transcript and the second transcript, iteratively comparing each word of the first transcript with a corresponding word of the second transcript;
generating a set of indicators indicating the words of the first transcript that are absent from the second transcript; and
causing the set of indicators to be presented on the client device.

3. The method of claim 2, further comprising:
applying the AI model to obtain a third transcript by:
supplying the second transcript of the audio file into the AI model, and
receiving the third transcript including the second segments indicated by the one or more retakes within the first transcript.

4. The method of claim 2, further comprising:
obtaining a third transcript including textual content related to the audio file; and
partitioning the third transcript into a plurality of text subsets of the textual content based on a ruleset,
wherein the first transcript is a text subset within the plurality of text subsets.

5. The method of claim 4,
wherein the ruleset dynamically adjusts a size of each of the plurality of text subsets based on complexity of the textual content within the third transcript based on clause density or grammatical complexity associated with the third transcript,
wherein the clause density is measured by dividing a total number of grammatical clauses of the textual content by a total number of words of the textual content,
wherein the grammatical complexity represents a measure of syntactic variety of the textual content, and
wherein the ruleset systematically decreases the size of each of the plurality of text subsets when there is high clause density or high grammatical complexity of the textual content and increases the size when there is low clause density or low grammatical complexity of the textual content.

6. The method of claim 4,
wherein the ruleset dynamically adjusts a size of each of the plurality of text subsets based on positions of sentences of the textual content within the third transcript,
wherein the ruleset begins each text subset of the plurality of text subsets with a beginning position of a first sentence and ends with an end position of a second sentence subsequent to the beginning position of the first sentence.

7. The method of claim 2, wherein the presentation of the set of indicators on the client device includes the words of the first transcript absent from the second transcript.

8. The method of claim 2, further comprising:
receiving a user input associated with one or more indicators of the set of indicators; and
subsequent to receiving the user input, removing the words of the first transcript absent from the second transcript indicated by the one or more indicators from the first transcript.

9. A non-transitory, computer-readable storage medium storing instructions for editing a video, wherein the instructions when executed by at least one data processor of a system, cause the system to:
acquire, from a client device, an input that includes (i) a first audiovisual file and (ii) a transcript that is representative of words spoken within the first audiovisual file;
for each layout in a set of layouts, assign a score that is based on a degree of relevancy of that layout to a corresponding portion of the first audiovisual file;
apply, to the first audiovisual file and the transcript, an artificial intelligence (AI) model that produces, as output, an identification of a set of scenes of the first audiovisual file,
wherein each scene in the set of scenes is a portion of the first audiovisual file;
for each portion of the first audiovisual file corresponding to a scene within the set of scenes, map a layout within the set of layouts to that portion based on the assigned score;
generate a second audiovisual file including the mapped layouts of the set of scenes; and
cause the second audiovisual file to be presented on the client device.

10. The non-transitory, computer-readable storage medium of claim 9, wherein the set of scenes is a first set of scenes, wherein the instructions further cause the system to:
receive, from the AI model, a second set of scenes of the first audiovisual file, wherein each scene in the second set of scenes includes a plurality of scenes from the first set of scenes.

11. The non-transitory, computer-readable storage medium of claim 9,
wherein mapping the layout within the set of layouts to the portion based on the assigned score is based on a predefined order of the set of layouts.

12. The non-transitory, computer-readable storage medium of claim 9,
wherein mapping the layout within the set of layouts is based on a cooldown parameter associated with the layout,
wherein the cooldown parameter is expired.

13. The non-transitory, computer-readable storage medium of claim 9, wherein the instructions further cause the system to:
receive a user input, via the client device, indicating a new layout; and
add the new layout to the set of layouts.

14. The non-transitory, computer-readable storage medium of claim 9, wherein the degree of relevancy of the layout to the corresponding portion of the first audiovisual file is higher when the corresponding words of the transcript match words indicated within the layout.

15. The non-transitory, computer-readable storage medium of claim 9, wherein the instructions further cause the system to:
receive, from the AI model, a set of keywords of each scene in the set of scenes representative of the words within the corresponding scene,
wherein mapping the layout within the set of layouts is based on the set of keywords for the corresponding scene.

16. A system comprising:
at least one hardware processor; and
at least one non-transitory memory storing instructions, which, when executed by the at least one hardware processor, cause the system to:
receive, from a client device, an input that includes (i) a first audiovisual file and (ii) a textual transcript that is representative of words spoken within the first audiovisual file;
apply a first artificial intelligence (AI) model to generate a first set of clips of the audiovisual file by:
supplying the first audiovisual file and the textual transcript into the first AI model, and
receiving, from the first AI model, the first set of clips of the first audiovisual file,
wherein each clip in the first set of clips is a portion of the first audiovisual file;
apply a second AI model to generate a set of topics of the audiovisual file by:
supplying the first audiovisual file and the textual transcript into the second AI model, and
receiving, from the second AI model, the set of topics of the first audiovisual file,
wherein each topic in the set of topics is associated with one or more portions of the first audiovisual file;
for each topic of the set of topics, determine whether each clip of the first set of clips is representative of that topic;
generate a second audiovisual file including a second set of clips of the first audiovisual file,
wherein each clip within the second set of clips is representative of at least one topic of the set of topics; and
present an indicator of the second audiovisual file on the client device.

17. The system of claim 16, wherein the system is further caused to:
for each clip of the first set of clips, assign a score based on whether each clip of the first set of clips is representative of the topic of the set of topics,
wherein the second set of clips includes clips of the first set of clips with an assigned score above a threshold score.

18. The system of claim 17, wherein the second set of clips is determined based on a prioritized order of the first set of clips, wherein the prioritized order of the first set of clips is determined based on the assigned score of each clip of the first set of clips.

19. The system of claim 16, wherein each clip in the first set of clips has a length below a predetermined threshold.

20. The system of claim 16, wherein presenting the second audiovisual file on the client device further causes the system to:
display, via an interface, a first graphical representation including the second set of clips of the first audiovisual file, and a second graphical representation including the first audiovisual file.

21. The system of claim 16, wherein presenting the second audiovisual file on the client device further causes the system to:
display, via an interface, the second audiovisual file.
